(19) United States
(12) Patent Application Publication
(10) Pub. No.: US 2019/0239602 A1
(43) Pub. Date: Aug. 8, 2019

(54) PARAMETRIZABLE WRIST WATCH

(71) Applicant: Dimitrios BARTZAS, Arta (GR)

(72) Inventor: Dimitrios BARTZAS, Arta (GR)

(21) Appl. No.: 16/318,837

(22) PCT Filed: Jul. 18, 2017
(86) PCT No.: PCT/GR2017/000044

§ 371 Date: Jan. 18, 2019

(30) Foreign Application Priority Data
Jul. 22, 2016 (GR) 20160100403

(51) Int. Cl. A44C 5/14

(52) U.S. Cl. CPC A44C 5/147; G04B 37/16

(57) ABSTRACT

Parametrizable wrist watch which consists of a strap (1) and an indication mechanism (2). The indication mechanism (2) consists of a base (3), which has threads (8) to be screwed to a respective mounting ring (6), which respectively has threads (7). Between them the function mechanism (4) and the glass (5) are enclosed. The base (3) has at its lower part, some sockets or incisions (9), which are used for the connection of the indication mechanism (2) with buttons (10) on a surface (11). The surface is connected to the strap (1) by pins, or the strap itself presents said buttons (10) for connection with the base (3) via said sockets or incisions (9).

### STATE OF THE ART

The invention relates to the field of wrist watches and in particular to a wrist watch which a user can parametrize, combining various straps with various indication mechanisms.

### BACKGROUND OF THE INVENTION

The parametrizable wrist watch disclosed in the present invention has not been disclosed in the prior art.

Wrist watches constitute common items, as well as items for the prominence of the owners. A watch is more than simply a time presentation instrument. There are various choices, either as regards the technical features and the quality of the materials and the complexity of the operations a watch has.

In the marker, there are analogue or digital watches, made of metal, silver or gold, with a strap made of leather or rubber, with an indication of the time or other data, such as day, date, inverse measurement, timer or more complex data such as altitude or moon phase. Thus, the user may select a watch that suits him, serve him and satisfies him both from a functional and from an aesthetic view.

One of the major problems facing a client when selecting a watch is the need that he is absolutely sure that his selection, especially if it is expensive, will cover his needs and desires over time. The watch, being a timeless item with a long lifetime, must ensure that it is always in fashion. It is not rare that a watch may be kept aside since it does not suits or aesthetically satisfies the user, although operating without problems.

Another common problem for the wrist watch owners is their partial wear, especially on the straps, the glass or the ring of the watch, thereby making it anti-aesthetic or non-functional. It is often necessary to visit a technician to repair the worn parts by the use of special tools. This repairing work both increase the cost, since various special tools are required, and make the owner to put the watches aside until future repair.

Another disadvantage of the currently known watches is that they often do not fully satisfy the candidate buyers, since a specific part thereof may be considered undesirable. For example, a watch may have a ring that a candidate buyer may not like it or it may have an analogue display, while the candidate buyer would prefer a digital one. This may lead to a rejection of a selection, since the individual parts cannot be changed and parametrized according to the individual buyer.

It is an object of the present invention to address advantageously the above-mentioned disadvantages and deficiencies, of the prior art by proposing a fully parametrizable wrist watch.

A further object of the present invention is to provide a parametrizable wrist watch, which is characterized by its originality and can be adapted to the needs and desires of the user.

A further object of the present invention is to provide a parametrizable wrist watch, which can be varied without using special tools and without the intervention of skilled personnel, by disconnecting the indication mechanism from the watch strap.

A further object of the invention, in order to make it the above watch useful for the public, is the ability to connect the watch to the individual strap in various ways. These, according to the desired applications, may include connection with magnets, connection with connection buttons, or even with Velcro.

A further object of the invention is to present a parametrizable wrist watch which has incisions on the base, so that by turning the hour indication the user essentially changes easily the time indication to summer or winter time.

Another object of the invention is to provide a parametrizable wrist watch, which has either a mechanical indication system or an electronic indication system, depending on the individually desired application.

An object of the present invention is also to provide a parametrizable wrist watch, which has a dial made of various materials, including steel, wood, brass or plastic.

Another object of the present invention is to also to provide a parametrizable wrist watch, which has a strap made of various materials, including leather, silicone, fabric or metallic bracelet.

These and further objects, features and advantages of the invention will be apparent by the following detailed description.

### BRIEF DESCRIPTION OF THE FIGURES

The invention will be apparent to those skilled in the art with reference to the accompanying figures in which the invention is shown in an exemplary, non-limiting way.

FIG. 1 shows in perspective view the parametrizable wrist watch of the present invention.

FIG. 2 shows in perspective view a detail of the connection of the wrist base, where the connection clips of the dial with its strap are depicted.

FIG. 3 shows in perspective view the individual parts constituting the detachable mechanism of the watch. The mechanism of the wrist, its base, its glass as well as the assemblying ring are shown.

FIG. 4 shows a mounting ring of the dial, where the threads are shown in the interior.

FIG. 5 shown in front view the base of the watch and its threads for its connection to the mounting ring.

FIG. 6 shows an exemplary variation of the invention, wherein the strap of the watch incorporates the connection buttons with its dial, showing an alternative embodiment of the invention.

FIG. 7 shows in cross-section the base of the watch where the sockets are shown in which the respective connection buttons of the strap are snapped.

### DETAILED DESCRIPTION OF A PREFERRED EMBODIMENT

Referring now to the accompanying figures, we will describe exemplary embodiments of the parametrizable wrist watch of the present invention, so that it is fully understood.

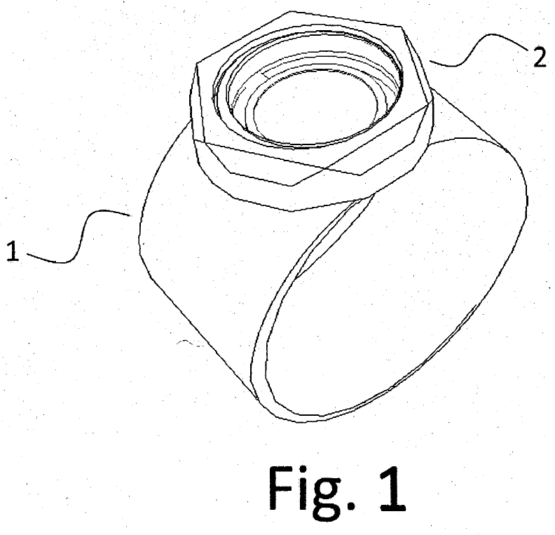

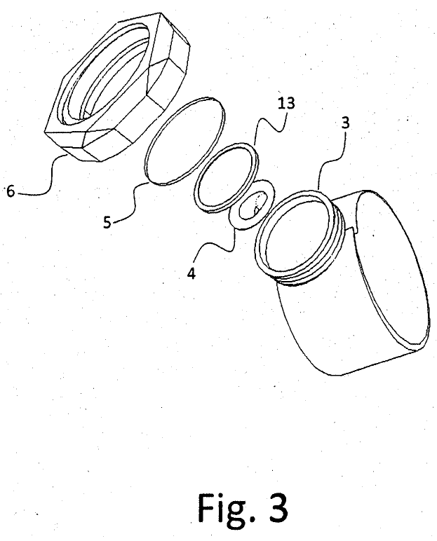

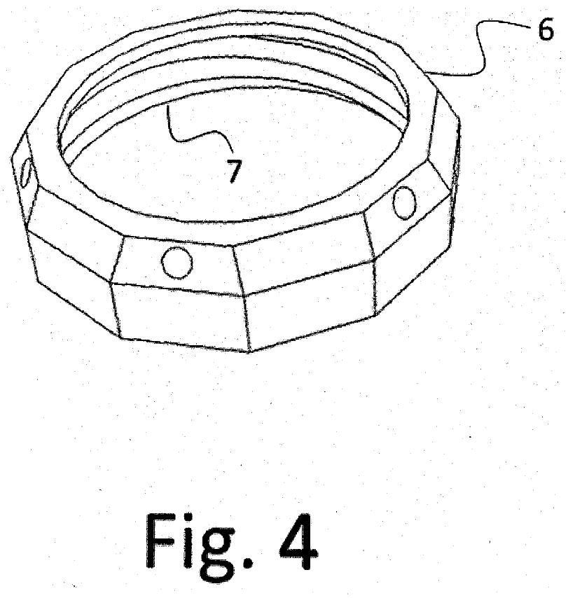

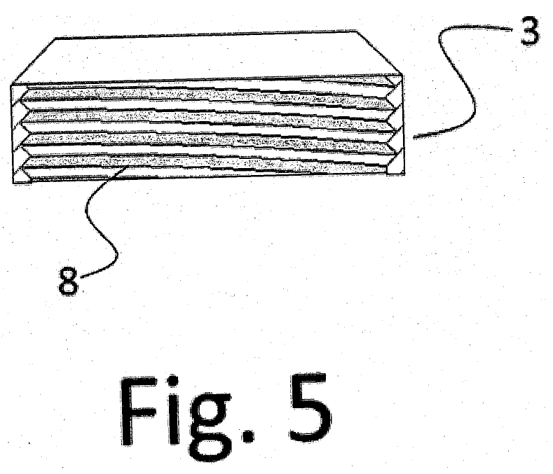

The parametrizable wrist watch consists of a strap (1), FIG. 1 and a detachable indication mechanism (2). The detachable indication mechanism (2) of the watch consists of a base (3), FIG. 3, in which the function mechanism (4) of the watch is mounted. Above that, a glass (5) for the protection of the function mechanism (4) and a flange (13) for full sealing are positioned, while a mounting ring (6) constitutes the connecting element with the base (3) of the watch. The connection is achieved by threads (7) on the mounting ring (6), FIG. 4, with which it is screwed to the base (3), which also has corresponding threads (8), FIG. 5. This allows combining various elements, such as the base (3), the function mechanism (4), the glass (5) and the mounting ring (6) depending on the individual demands and choices of the user.

Thus, in an exemplary embodiment of the invention, the mounting ring (6) may be made of steel, however in other exemplary embodiments it is made of brass, wood, plastic or other suitable material. Furthermore, it may have various colors, inscriptions or decorations with precious stones, depending on the respective choices. It may also have an octagonal shape, or a circular shape and various size, as long as the other parts have such dimensions so that they assembled between them. Similarly, the glass (5) may be made of tempered glass, coloured glass, with patterns or clear, however it may also be made of other materials, exemplarily plastic or polycarbonate. In another exemplary embodiment, the function mechanism (4) may be analogue or digital, without affecting the function of the watch.

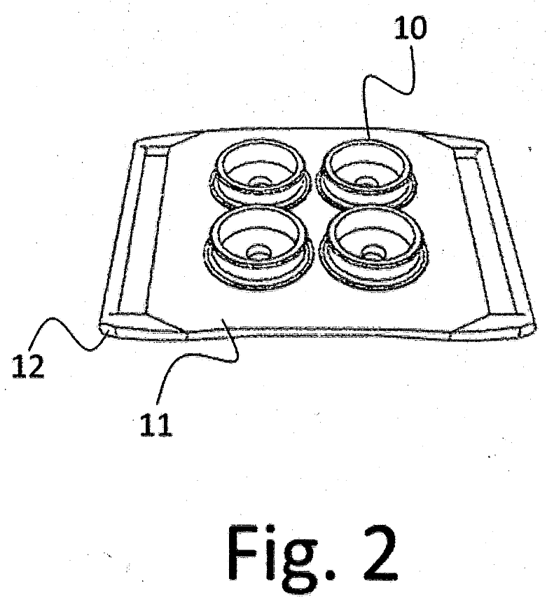

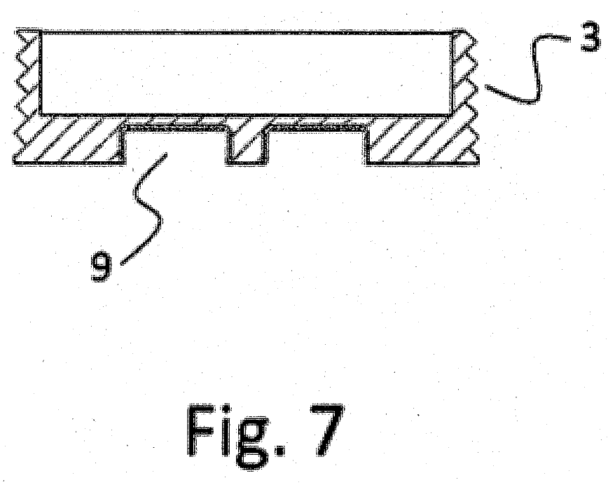

The base (3) has at its lower part sockets (9), FIG. 7, by which it is snapped on the connection buttons (10) on a surface (11), FIG. 2. The surface (11) is essentially an extension or part of the strap (1). The sockets (9) allow easy mounting of the detachable indication mechanism (2) to the individually used strap (1). By this way, any combination of the available parts may be made, so that the watch has the elements that the owner desires. In alternative embodiments of the invention, the base (3) has, instead of sockets (9), the connection buttons (10) and the surface (11) has the sockets (9), while it may also have for example magnets so that it is connected to a corresponding magnet on the surface (11) or alternatively respective Velcro may also be used.

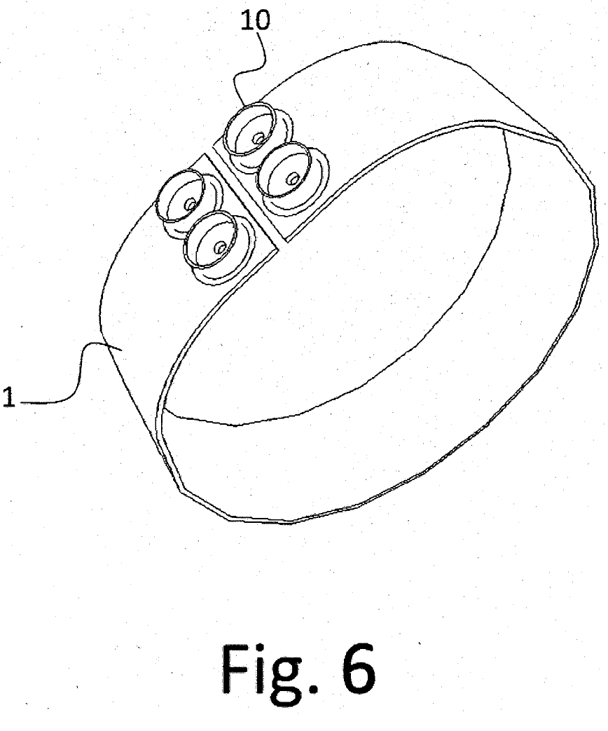

In an alternative embodiment of the invention, the strap (1), may consist of two different parts which are connected by a means of a pin passing through the elongate holes (12) to the surface (11) before the indication mechanism (2) selected by the user is snapped on the button. In another exemplary embodiment of the invention the strap (1) does not have a separate snapping, but may be a single one, FIG. 6, and on its upper part the connection buttons (10) are provided by means of which it is connected to the indication mechanism (2). In this way, when the user wants to take off the watch, he simply removed the indication mechanism (2) from the connection buttons (10) and then removed the strap (1) from his hand. In another exemplary embodiment of the invention, the strap (1) may be metallic bracelet with a single snapping, while it should be noted that straps made of leather, fabric, cloth or silicon may be used according to the individual selections by the manufacturer.

It should be noted that the description of the invention was made with reference to exemplary, non-limiting embodiments. Thus any variation or modification as regards shape, dimensions, construction/assemblage materials and components used, as long as not constituting a new and inventive step and not contributing to the technical advance of the already known, are considered as encompassed in the scope of the present invention.

1. A parametrizable wrist watch consisting of a strap (1), with a surface (11) on which connection buttons (10) are provided, an indication mechanism (2), assembled from a base (3), which peripherally has threads (8) and at its lower part incisions (9), an function mechanism (4), a glass (5) and an mounting ring (6), with threads (7) peripherally, characterized in that on the base (3) the function mechanism (4) is placed, the glass (5) is placed and screwed by the threads (8) to the respective threads (7) of the mounting ring (6), forming the indication mechanism (2) which is snapped with the connection buttons (10) on the strap (1).

2. A parametrizable wrist watch according to claim 1, characterized in that the surface (11) has elongate holes (12) which are used for the connection by pins to the strap (1).

3. A parametrizable wrist watch according to claim 1, characterized in that the strap (1) is single and has at its two ends the connection buttons (10), by which it is snapped in the sockets (9) of the indication mechanism (2).
